(19) United States
(12) Patent Application Publication
(10) Pub. No.: US 2004/0144266 A1
(43) Pub. Date: Jul. 29, 2004

(54) Baling press cart

(76) Inventor: Guanghui Xue, Gatineau (CA)

Correspondence Address: GUANGHUI XUE, 24 DE LA SAVANE, GUTINEAU, QC, J8T 1P7, CA

(21) Appl. No.: 10/601,291

(22) Filed: Jun. 23, 2003

(30) Foreign Application Priority Data
Jan. 23, 2003 (CA) 2416317

(51) Int. Cl. B30B 7/00; B30B 5/00

(52) U.S. Cl. 100/233

(57) ABSTRACT

The invention provides a cardboard baling press cart of the manual operated type, used for baling loose cardboard. This baling press cart includes a two layer rack and a movable baling ram which moves horizontally back and forth in-between the front and back frame within the center space of the upper layer of the rack. The baling ram is moved by two struts, which are hinge jointed together. The lower strut is hinge jointed to the lower layer of the rack and the upper strut is attached to the bottom of the baling ram. A tension spring is attached under the baling ram to provide resilience to relocate the baling ram.

### BACKGROUND OF THE INVENTION

There are presently automatic cardboard compactors which are electro/hydraulically driven, big in size, and high in cost. Most small to medium scope commercial/institutional working conditions require a simple solution for baling cardboard that large compactors cannot provide. Generally, there is a need for a cardboard baling press that is easy to use, low in cost, mobile and suitable for small to medium commercial/institutional working environments. The primary objective of the present invention is to provide a new apparatus which addresses this need.

### BRIEF SUMMARY OF THE INVENTION

The broad aspect of the present invention is an apparatus for baling loose cardboard. This invention comprises a rack which includes an upper layer, a lower layer, a front frame, a back frame and a baling-ram-driving-relocating-mechanism.

The baling-ram-driving-relocating-mechanism comprises a baling ram, a baling-ram-driving-assembly and a baling-ram-relocating-assembly. The baling-ram-driving-assembly includes two struts. The baling-ram-relocating-assembly includes a tension spring and a relocating bar.

The upper layer space of the rack is a two-sided open area which includes the front and back frame leaving the left and right sides open. This upper layer space is the processing area for holding and baling loose cardboard.

At the center of the upper layer is a pair of horizontally parallel channels that are perpendicular to the front and back frame. The slots of the parallel channel face each other.

The baling ram is a right-angle-head formed by channel steel with its slot facing the interior angle. On the horizontal section of the baling ram are two pins which point outwards on both outer edges. These pins slide horizontally within the parallel channels of the upper layer of the rack.

The baling-ram-driving-assembly comprises two struts which are hinge jointed to each other. This assembly provides baling pressure to the baling ram. The lower strut of the baling-ram-driving-assembly is hinge jointed to the horizontal center bar of the lower layer. The upper strut of the baling-ram-driving-assembly is hinge jointed to the bottom of the baling ram.

Under the baling ram, is a relocating tension spring, which provides resilience for relocating the baling ram. The tension spring is attached between the bottom of the baling ram and the front frame of the rack following the direction of the bailing ram's movement.

The baling-ram-driving-assembly and baling-ram-relocating-assembly are located in the lower layer space of the rack.

### BRIEF DESCRIPTION OF THE DRAWINGS

FIG. 1 is a lateral view of the apparatus in accordance with the present invention.

FIG. 2 is a side elevation view of the invention, showing the apparatus loaded with loose cardboard before the process of baling.

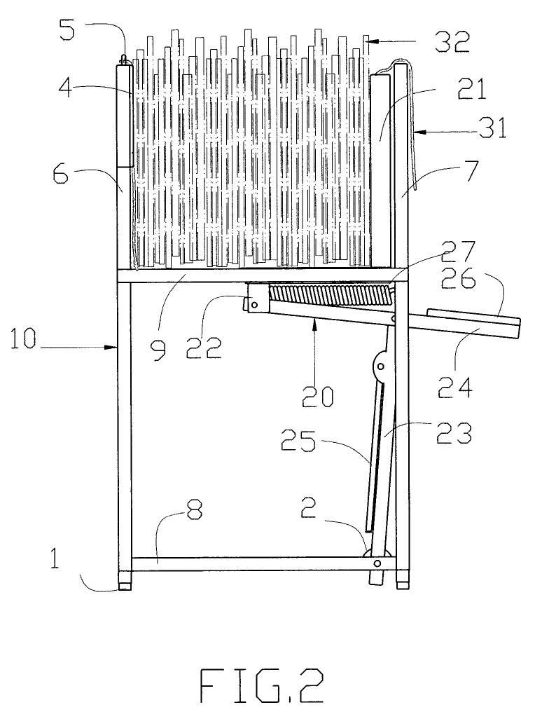

FIG. 3 is a side elevation view of the invention, showing the baling ram in the baling position compressing cardboard into a compact form, with the two struts of the baling-ram-driving-assembly in alignment.

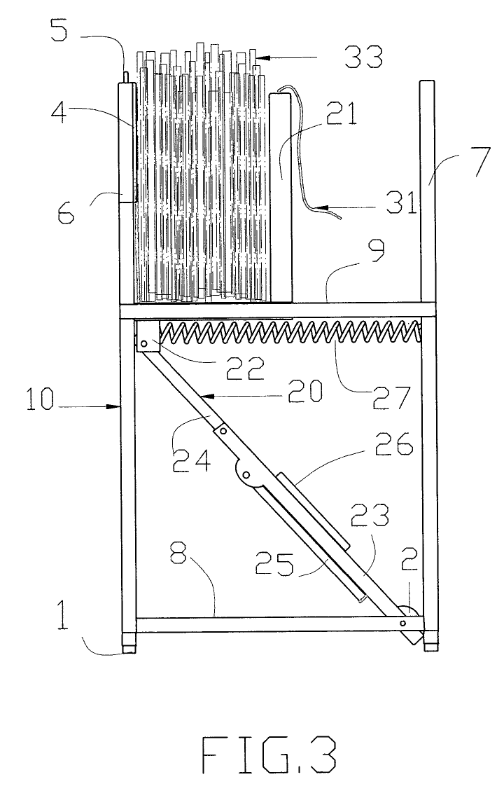

FIG. 4 is a lateral view of the baling-ram-driving-relocating-mechanism, showing the baling ram is in the baling position and two struts are in alignment. With some parts of the rack deleted for clarity of illustration and some parts of the front frame remaining for reference.

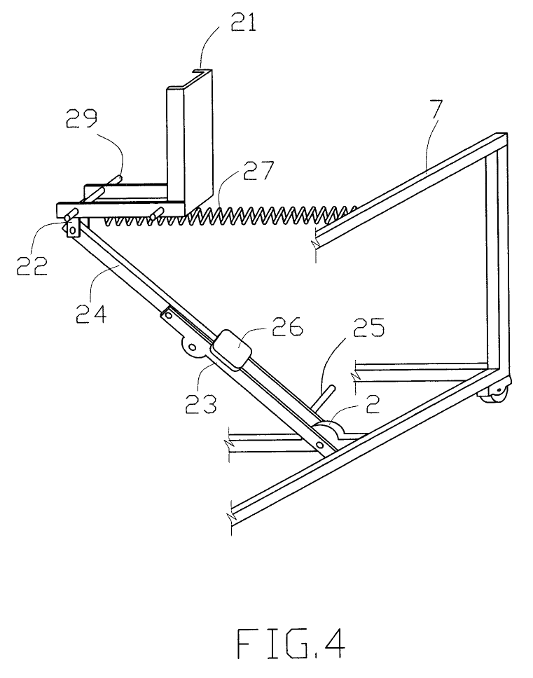

FIG. 5 is a view similar to FIG. 4, showing the relocating pedal in the process of relocating the baling ram.

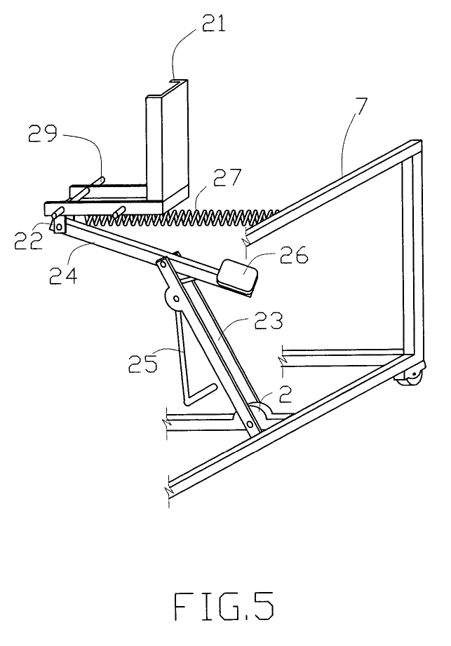

FIG. 6 is a view similar to FIG. 4, showing the baling ram has been relocated.

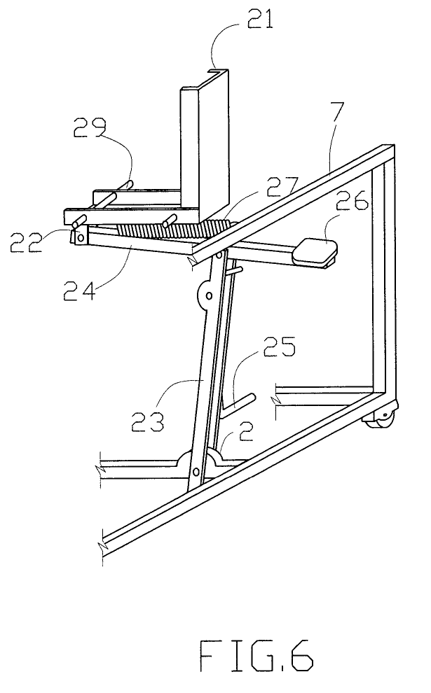

FIG. 7 is the cross-sectional view of the pair of parallel channels and the horizontal section of the baling ram, showing pin in the slots of the channels and the baling ram in-between the parallel channels. With some parts deleted for clarity of illustration.

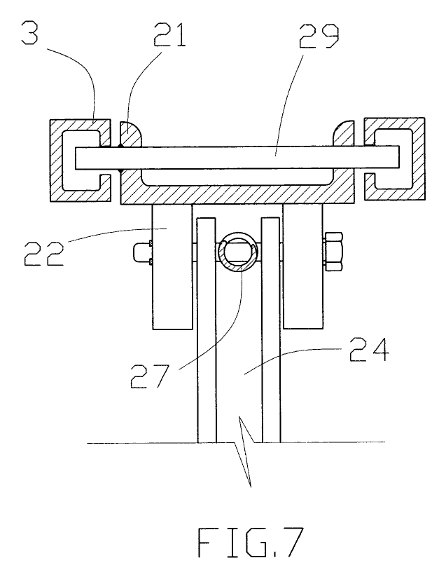

### DETAILED DESCRIPTION OF THE INVENTION

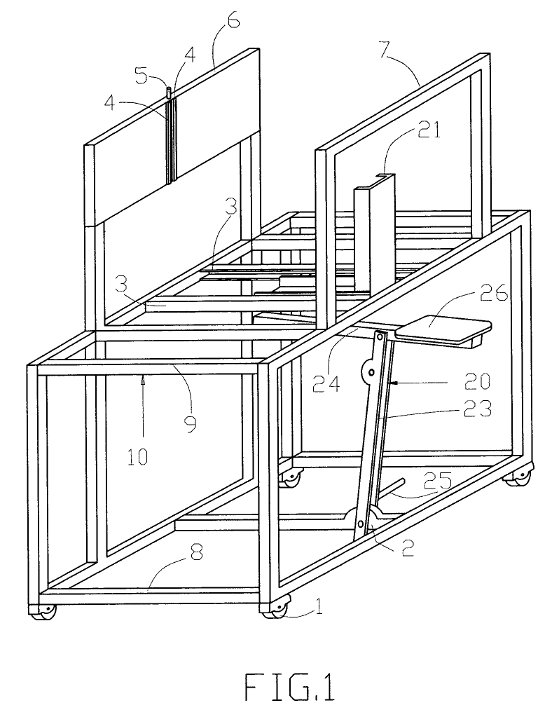

The manual operated cardboard baling press cart shown in the FIG. 1 includes the rack (10), the baling-ram-driving-relocating-mechanism (20).

The rack (10) is divided into an upper layer area and a lower layer area. This rack is a metal frame consisting of an upper layer (9), a lower layer (8), a front frame (7), and a back frame (6). The rack is supported by four wheels (1). The upper layer space of the rack is a two-sided open area which includes the front frame (7) and back frame (6) leaving the left and right sides open.

Centered on the upper layer (9), horizontally is a pair of parallel channels (3) that are perpendicular to the front frame (7) and the back of the frame (6). The slots of channels (3) face each other.

There are two bars on each outer side of the channels (3). These bars are perpendicular to the front frame (7) and the back frame (6) thus forming a horizontal platform which is designated as the upper layer (9) of the rack.

On the upper portion of the back frame (6), there are two ridges (4) on each bar which face the baling ram (21). The ridges (4) are located on each side of the center line of the parallel channels (3) symmetrically.

On the top of the back frame (6), is a rope hanger (5) which points upward. This is used as an anchor point for the rope (31) to tie the bundle of compact form of cardboard (33) after baling.

The baling-ram-driving-relocating-mechanism (20) includes a baling ram (21), a baling-ram-driving-assembly and a baling-ram-relocating-assembly.

The baling ram (21) is a right-angle-head made of channel steel with its slots facing the interior angle. The width of the baling ram (21) is smaller than the interval between the two parallel channels (3).

Perpendicular to the horizontal section of the baling ram (21) are two pins (29) pointing outwards. The outer diameter of the pins (29) is smaller than the width of the slot of the parallel channel (3) in which the pins (29) roll thus moving the baling ram horizontally on the center line of the parallel channels (3) from the front frame (7) side towards the back frame (6) side back and forth.

The baling-ram-driving-assembly comprises an upper strut (24) and a lower strut (23). At the middle of the upper strut (24) and the upper end of the lower strut (23), the two struts are hinge jointed together.

Under the horizontal section of the baling ram (21), there are two lugs (22) on which the top end of the upper strut (24) is hinge jointed to the baling ram.

At the lower end of the upper strut (24), is a baling pedal (26).

The baling-ram-relocating-assembly comprises a tension spring (27) and a relocating bar (25). The relocating pedal (25) is hinge jointed to the lower strut (23) below where the upper strut (24) and the lower strut (23) are hinge joint together.

The tension spring (27) is attached under the baling ram (21) following the direction of the baling ram's movement. One end of this tension spring (27) is attached to the lugs (22) under the bailing ram (21) and the other end of this tension spring (27) is attached to the front frame (7).

At the lower layer (8) is a horizontal center bar which is perpendicular to the front frame (7) and the back frame (6). At the front end of the center bar is a convex lug (2). At this convex lug (2), the lower end of the lower strut (23) is hinge jointed to the rack (10).

The baling-ram-driving-assembly and the baling-ram-relocating-assembly are installed in the area between the lower layer (8) and the upper layer (9) of the rack.

In the processing of baling, the operator first attaches the back end of the rope (31) to the rope hanger (5). The operator then lays the rope (31) in between the ridges (4) and into the channel of the baling ram (21), leaving the loose front end of the rope (31) hanging over the front frame (7). The operator then, vertically, places the loose cardboard (32) onto the upper layer (9) of the rack across the parallel channel (3). The operator then places his/her foot on the baling pedal (26) and presses until the upper strut (24) and the lower strut (23) align, thus moving the baling ram into the baling position compressing the loose cardboard (32) into a compact form of cardboard (33). Then, the anchored back end of the rope (31) is tied to the loose front end of the rope by the operator, thus tying the compact form of cardboard (33) into a portable tied bundle.

To relocate the baling ram (21), the operator sets his/her foot on the relocating bar (25), presses the bar downward. This motion causes the opposite end of the relocating bar (25) to unlock the alignment of the upper strut (24) and the lower strut (23). Therefore, under the resilience of the tension spring (27), the baling ram (21) moves back into the start position.

After the baling ram is relocated, the tied compact form of cardboard (33) is free from baling pressure and ready to be removed from the upper layer space of the rack. The operator removes the tied bundle of compact cardboard from the upper layer space of the rack and the baling press cart is ready to repeat the process again.

This invention provides the following advantage:

(1) The structure of the hinge jointed struts of the baling-ram-driving-assembly provides magnified baling pressure with limited manpower.

(2) Mobile in a small working area where loose cardboard is discarded.

(3) Low in cost, easy to operate and easy to maintain.

The embodiments of the invention in which an exclusive property privilege is claimed are defined as follows:

1. A manual operated baling press cart comprises a two layer rack in which a baling ram moves horizontally in the upper layer area of the rack.

2. A manual operated baling press cart as defined in claim 1, the upper layer area is a two-sided open space.

3. A manual operated baling press cart as defined in claim 1 and claim 2, in which the upper layer of the rack consists of at least one pair of parallel channels with the slots of the channels facing each other.

4. A manual operated baling press cart as defined in claim 1 and claim 3, in which the baling ram consisting of at least four track rollers that slide in the parallel channels that defined in claim 3.

5. A manual operated baling press cart as defined in claim 1, in which the baling ram is driven by a hinge jointed strut assembly including two struts.

6. A manual operated baling press cart as defined in claim 1 and claim 5, in which the upper strut of the hinge jointed strut assembly is hinge jointed to the baling ram.

7. A manual operated baling press cart as defined in claim 1 and claim 5, in which the lower strut of the hinge jointed strut assembly is hinge jointed to the center bar of the lower layer of the rack.

8. A manual operated baling press cart as defined in claim 1 comprises a tension spring which is attached under the baling ram.

9. A manual operated baling press cart as defined in claim 1 and claim 5, in which a relocating bar is hinge jointed to the lower strut of the hinge jointed assembly.

10. A manual operated baling press cart as defined in claim 1, in which the rack is supported by at least 4 wheels.
